(19) United States
(12) Patent Application Publication
(10) Pub. No.: US 2019/0392641 A1
(43) Pub. Date: Dec. 26, 2019

(54) MATERIAL BASE RENDERING

(71) Applicant: Sony Interactive Entertainment Inc., Tokyo (JP)

(72) Inventors: Michael Taylor, San Mateo, CA (US); Glenn Black, San Mateo, CA (US); Javier Fernandez Rico, San Mateo, CA (US)

(21) Appl. No.: 16/019,240

(22) Filed: Jun. 26, 2018

(51) Int. Cl. G06T 19/00; H04R 1/10; G10L 15/08; G02B 27/01; G10L 25/54; H04R 3/00

(52) U.S. Cl. CPC G06T 19/006; H04R 1/1041; G10L 15/08; G02B 2027/0138; G10L 25/54; H04R 3/00; G02B 27/0172

(57) ABSTRACT

An augmented reality (AR) system adapts sounds based on the physical properties of real world materials found in a user's environment through material classification to sound modification. The sounds may be emulated sounds of virtual objects being emulated to impact real world objects in the AR space.

### FIELD

The present application relates to technically inventive, non-routine solutions that are necessarily rooted in computer technology and that produce concrete technical improvements.

### BACKGROUND

In augmented reality (AR), virtual objects are mixed with real objects. An example technique for achieving this is a headset with a partially transparent display onto which images of virtual objects are presented and through which a wearer can see real world object nearby.

### SUMMARY

As understood herein, the AR experience can be improved by accurately emulating sound to account for the material and shape and other structural factors of real world objects in emulated AR space, such as the sound of virtual objects appearing to strike real world objects. In specific implementations, an AR system adapts sounds based on the physical properties of the materials found in a user's environment using a multi-step process from material classification to sound modification.

A specific example includes a virtual ball thrown against real-world objects in a room, with different emulated sounds being played of the ball bounce based on which material it bounced off of, as well as the angle and force of the throw

Accordingly, as envisioned herein, a storage device includes at least one computer medium that is not a transitory signal and that in turn includes instructions executable by at least one processor to identify at least one surface characteristic of at least one real world object in an augmented reality (AR) setting. The instructions are executable to identify at least one contact of at least one virtual object against the real-world object in the AR setting, and generate audio representing the contact based at least in part on the characteristic.

An AR headset may be configured for playing the audio and the virtual object may be a ball.

In example embodiments, the surface characteristic includes a surface material. The surface characteristic can include an angular aspect relative to the virtual object. Moreover, in some embodiments the instructions may be executable to establish the audio based at least in part on an emulated relative speed between the real-world object and the virtual object.

In another aspect, a method includes classifying at least one structural material of at least one real world object for augmented reality (AR). The method also includes adapting audio at least in part based on the classifying for play of the audio to emulate interaction with the real-world object.

In another aspect, an augmented reality (AR) system includes at least one audio speaker and at least one processor configured to control the speaker to play audio thereon. The processor is configured with instructions for causing the speaker to play first audio responsive to interaction of a virtual object with a first real-world object based at least n part on a first classification associated with the first real world object. The instructions are further executable for causing the speaker to play second audio responsive to interaction of the virtual object with a second real world object based at least in part on a second classification associated with the second real world object.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example specific AR system;

FIGS. 3 and 4 are schematic diagrams of a virtual object emulated as striking a real-world object;

FIG. 5 is a block diagram of an example speaker circuit;

FIG. 6 is a flow chart of example logic consistent with present principles; and

FIG. 7 is a schematic of an example data structure consistent with present principles.

### DETAILED DESCRIPTION

This disclosure relates generally to e ecosystems including aspects of consumer electronics (CE) device networks such as but not limited to computer game networks. A system herein may include server and client components, connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

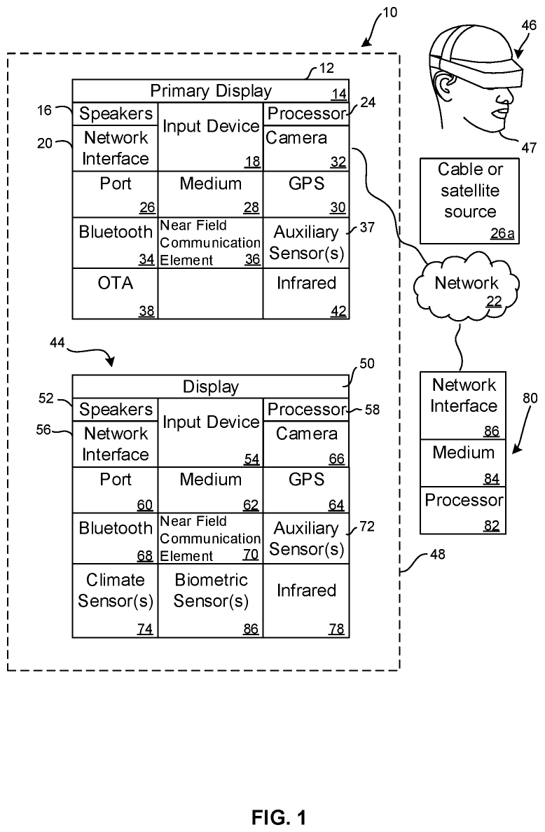

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). However, the AVD 12 alternatively may be an appliance or household item, computerized Internet enabled refrigerator, washer, or dryer. The AVD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g. communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as e.g., an audio receiver/microphone for e.g. entering audible commands to the AVD 12 to control the AVD 12. The example AVD 12 may also include one or more network interfaces 20 for communication over at least one network 22 such as the Internet, an WAN, an LAN, etc. under control of one or more processors 24 including. A graphics processor 24A may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVD 12 array also include one or more input ports 26 such as, e.g., a high definition multimedia interface (HDMI) port or a USB port to physically connect (e.g. using a wired connection) to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes described further below. The source 26a when implemented as a game console may include some or all of the components described below in relation to the CE device 44.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media. Also, in some embodiments, the AVD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVI) 12 is disposed in conjunction with the processor 24. However, it is to be understood that another suitable position receiver other than a cellphone receiver, GPS receiver and/or altimeter may be used in accordance with present principles to e.g. determine the location of the AVD 12 in e.g. all three dimensions.

Continuing the description of the AVD 12, in some embodiments the AVD 12 may include one or more cameras 32 that may be, e.g., a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC;) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVI) 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12.

Still referring to FIG. 1, in addition to the AVD 12, the system 10 may include one or more other CE device types. In one example, a first CE device 44 may be used to send computer game audio and video to the AVD 12 via commands sent directly to the AVD 12 and/or through the below-described server while a second CE device 46 may include similar components as the first CE device 44. In the example shown, the second CE device 46 may be configured as a VR headset worn by a player 47 as shown. In the example shown, only two CE devices 44, 46 are shown, it being understood that fewer or greater devices may be used.

In the example shown, to illustrate present principles all three devices 12, 44, 46 are assumed to be members of an entertainment network in, e.g., a home, or at least to be present in proximity to each other in a location such as a house. However, present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer or game controller (also referred to as “console”), and accordingly may have one or more of the components described below. The first CE device 44 may be a remote control (RC) for, e.g., issuing AV play and pause commands to the AVD 12, or it may be a more sophisticated device such as a tablet computer, a game controller communicating via wired or wireless link with the AVL) 12, a personal computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. A graphics processor 58A may also be included. Thus, the interface 56 may be, without limitation, a Wi-Fi transceiver, which is an example of a wireless computer network interface, including mesh network interfaces. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port, to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid-state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first GE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR. transceiver 78 such as an IR data association (IRDA) device. A battery (not shown) may be provided for powering the first CE device 44. The CE device 44 may communicate with the AVD 12 through any of the above-described communication modes and related components.

The second CE device 46 may include some or all of the components shown for the CE device 44. Either one or both CE devices may be powered by one or more batteries.

Now in reference to the afore-mentioned at least one server 80. It includes at least one server processor 82, at least one tangible computer readable storage medium 84 such as disk-based or solid-state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server or an entire server “farm” and may include and perform “cloud” functions such that the devices of the system 10 may access a “cloud” environment via the server 80 in example embodiments for, e.g., network gaming applications. Or, the server 80 may be implemented by one or more game consoles or other computers in the same room as the other devices shown in FIG. 1 or nearby.

The methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the Internet.

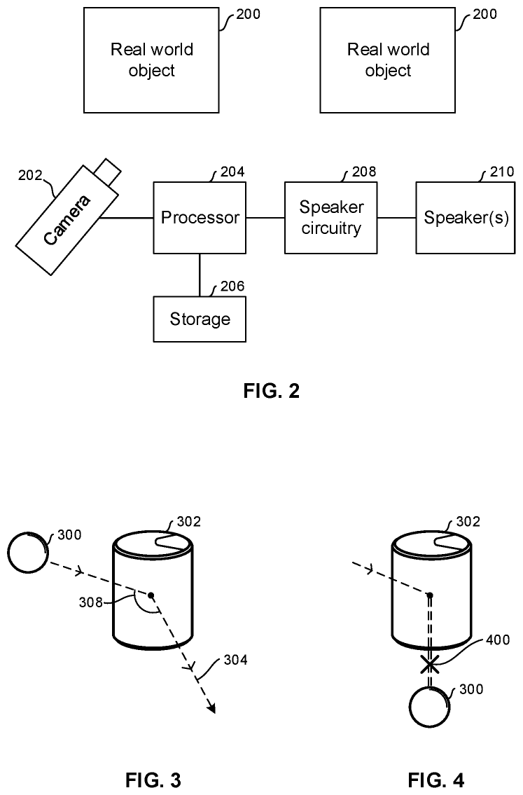

FIG. 2 shows a specific example AR system that may be implemented by any of the devices and components described above. First and second real world objects 200 may be imaged by one or more cameras 202 communicating image information to one or more processors 204 accessing instructions on one or more computer storages 206. The processor 204 controls speaker circuitry 208 to output audio on one or more speakers 210 according to disclosure below. The speaker(s) 210 may be mounted on an AR headset such as the device 46 shown in FIG. 1.

FIGS. 3 and 4 illustrate an example virtual object 300, in the example shown, a ball flying through the air and emulated to strike a real-world object 302, in the example shown, a cylindrical aluminum can. In FIG. 3 the ball glancingly contacts the can 302 as indicated by the flight path 304, which diverts the emulated trajectory of the ball 30( )by an oblique angle 308. In FIG. 4, however, the ball directly strikes the can 302 and bounces straight back as emulated in AR, as indicated by the double lines 400.

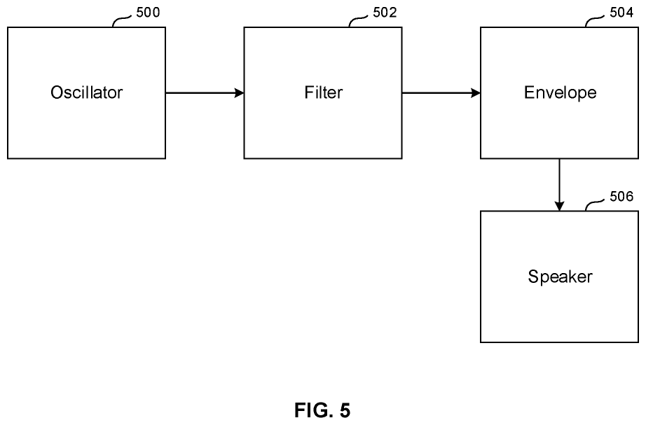

FIG. 5 shows a block diagram of an example speaker circuitry. The speaker circuitry may include a sound generator such as an oscillator 500. A filter 502 may receive sound signals from the generator 500 to filter out, e.g., certain frequencies or frequencies bands. A sound envelope 504 may receive the output of the filters 502 to envelop the sound signals. Essentially, the oscillator generates a sine wave, the filter transforms it, then the envelope changes the sound volume and if desired other characteristics. A speaker 506 transforms the sound signals to audio.

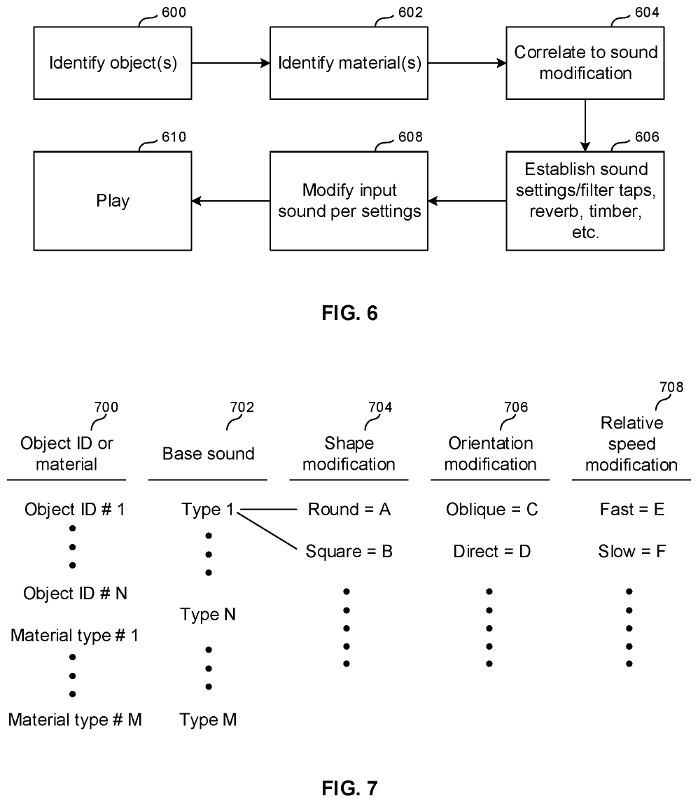

FIG. 6 is a flow chart of example logic consistent with present principles. Commencing at block 600, real world objects (e.g., the objects 200 in FIG. 2) in AR space are identified, as well as, if desired, respective materials of which the objects are composed, based on object recognition on, for example, images of the real-world objects from the camera 202. Alternatively, a user may be prompted to tap a real-world object and the resulting sound analyzed using, e.g., fast Fourier transforms to match it with one or more entries in an audio fingerprint database that are correlated to respective materials and/or objects. As yet another alternative, any of the speakers shown and described herein may be used to emit a sonic probe signal such as an ultrasound signal, with the reflections of the probe signals being matched to database entries in an audio fingerprint database that are correlated to respective materials and/or objects.

Moving to block 602, in addition to or in lieu of identifying objects per se, surface material types of real world objects may be identified in real time. This may be done by any of the techniques noted above. Thus, for example, it may be determined whether an object is made of metal, wood, linen, etc.

The shapes of the objects also can be determined. Also, the orientations of real world objects relative to virtual objects, as well as the relative speed therebetween, can be determined. One or more of the above characteristics may be correlated at block 604 to a sound or sound modification.

For example, once a characteristic of a real-world object has been identified, a database lookup can be executed to correlate that characteristic to a particular sound. Multiple characteristics may be used. An example data structure is shown in FIG. 7.

In FIG. 7, an object identification or identified object surface material may be used as entering argument to a first column 700. For each object ID or object material type, a second column 702 correlates a respective base sound. The base sound may be correlated to one or more additional modifications. For example, the base sound may be modified according to the shape of the object by a modification from a shape column 704. In the simplified example shown, for object ID #1, its base sound is type 1 which is modified by a factor “A” if the object is round and by a factor “B” if the object is square.

Similarly, the base sound may be modified according to the orientation of the object relative to a reference location, such as the location of a virtual object, by a modification from an orientation column 706. In the simplified example shown, for object ID #1, its base sound of type 1 is modified by a factor “C” when it bears an oblique orientation relative to the reference and by a factor “D” when it faces directly at the reference.

Likewise, the base sound may be modified according to the relative speed of the object relative to a reference, such as the speed of a virtual object, by a modification from relative speed column 708. In the simplified example shown, for object ID #1, its base sound of type 1 is modified by a modification “E” when the relative between the object and the reference is high or fast and by a modification “F” when the relative between the object and the reference is low or slow. It is to be understood that more than two modification entries in the columns 704, 706, 708 for each sound type in column 702 may be implemented.

Note that the data structure may also include correlations for virtual objects, typically defined by the game author, so that a composite sound may be generated when, e.g., a virtual object strikes a real-world object in AR space.

Once the base sound with modification(s), if any, have been identified at block 604, the sounds are implemented at block 606 by appropriately establishing the output of, e.g., the oscillator 500 of FIG. 5 and processing filters and envelopes described above to produce the sound output from block 604. 3D audio processing may be used at block 606 to produce the demanded audio by, e.g., distortion of signals produced by the sound source, e.g., the oscillator. This may be accomplished using various techniques including appropriately establishing filter taps, implementing reverberation, timber, etc.

Block 608 indicates that the input sound can be further modified according to certain pre-stored settings as desired by the system designer. The sound is played on one or more speakers at block 610 at the appropriate time, e.g., as a virtual object is emulated to strike the real-world object for which the sound is tailored.

In addition to effectively pre-training objects against certain materials in a matching library, the correlations described above may be dynamically generated using audio manipulations and customized reverberation.

In some implementations the material characteristics and other sound properties may be shared in a simultaneous localization and mapping (SLAM) map of a computer game. SLAM maps may even be used to identify the contour of a particular area of a real-world object that interacts with a virtual object to identify whether the virtual object interacts with the real-world object, e.g., at an oblique angle or direct angle according to the example above.

Training data may be used initially to model input objects, positions from interactions, and strengths of interactions. As an example, a tester may bounce real world objects later to be emulated by virtual objects off certain known materials to record the initial sound profiles, which are associated with the known materials in a data structure.

Essentially, transform functions may be implemented for different types of materials such as wood, metal, etc. and for specific object types if desired. Sound profiles may be obtained from previous player interactions and provided from cloud servers in networked games.

While particular techniques and machines are herein shown and described in detail, it is to be understood that the subject matter which is encompassed by the present invention is limited only by the claims.

What is claimed is:

1. A storage device comprising:
at least computer medium that is not a transitory signal and that comprises instructions executable by at least one processor to:
identify at least one surface characteristic of at least one real world object in an augmented reality (AR) setting;
identify at least one contact of at least one virtual object against the real-world object in the AR setting; and
generate audio representing the contact based at least in part on the characteristic.

2. The storage device of claim 1, comprising the at least one processor.

3. The storage device of claim 2, comprising at least one AR headset configured for playing the audio.

4. The storage device of claim 1, wherein the surface characteristic comprises a surface material.

5. The storage device of claim 1, wherein the surface characteristic comprises an angular aspect relative to the virtual object.

6. The storage device of claim 1, wherein the virtual object comprises a ball.

7. The storage device of claim 1, wherein the surface characteristic comprises a surface material and an angular aspect relative to the virtual object.

8. The storage device of claim 1, wherein the instructions are executable to:
establish the audio based at least in part on an emulated relative speed between the real-world object and the virtual object.

9. A method, comprising:
classifying at least one structural material of at least one real world object for augmented reality (AR);
adapting audio at least in part based on the classifying for play of the audio to emulate interaction with the real-world object.

10. The method of claim 9, comprising playing the audio on at least one AR headset.

11. The method of claim 9, comprising adapting the audio at least in part based on an angular aspect of the real-world object relative to a virtual object.

12. The method of claim 11, wherein the virtual object comprises a ball.

13. The method of claim 9, comprising adapting the audio at least in part based on an emulated relative speed between the real-world object and a virtual object.

14. An augmented reality (AR) system, comprising:
at least one audio speaker;
at least one processor configured to control the at least one speaker to play audio thereon, the at least one processor configured with instructions for:
causing the at least one speaker to play first audio responsive to interaction of a virtual object with a first real-world object based at least in part on a first classification associated with the first real world object; and
causing the at least one speaker to play second audio responsive to interaction of the virtual object with a second real world object based at least in part on a second classification associated with the second real world object.

15. The AR system of claim 14, wherein the first classification comprises a surface characteristic.

16. The AR system of claim 14, wherein the first classification comprises a surface material.

17. The AR system of claim 14, wherein the first classification comprises an orientation of the first real world object relative to the virtual object.

18. The AR system of claim 14, wherein the first classification comprises a relative speed.

19. The AR system of claim 14, wherein the speaker is in an AR headset.

20. The AR system of claim 14, wherein the virtual object comprises a virtual object emulated to be passing through air.
